(19) United States
(12) Patent Application Publication
(10) Pub. No.: US 2004/0247928 A1
(43) Pub. Date: Dec. 9, 2004

(54) Friction guard blade and a method of production thereof

(76) Inventor: Harry C. Morris, Moorestown, NJ (US)

Correspondence Address: Jane Massey Licata, Licata & Tyrrell P.C., 66 E. Main Street, Marlton, NJ, 08053, US

(21) Appl. No.: 10/840,052

(22) Filed: May 6, 2004

Related U.S. Application Data
(63) Continuation-in-part of application No. 09/768,710, filed on Jan. 24, 2001, now abandoned.
(60) Provisional application No. 60/242,107, filed on Oct. 20, 2000.

(51) Int. Cl. B32B 9/00

(52) U.S. Cl. 428/615; 428/686; 428/408

(57) ABSTRACT

A friction resistant blade having a protective layer with an increased hardness is provided. A method for producing the friction resistant blade is also provided.

### INTRODUCTION

This patent application is a continuation-in-part of U.S. patent application Ser. No. 09/768,710 filed Jan. 24, 2001 which claims the benefit of provisional patent application Serial No. 60/242,107 filed Oct. 20, 2000.

### FIELD OF THE INVENTION

This invention relates to prolonged life coater and doctor blades used in paper and printing applications and to methods of their production. Blades are the dominant means of applying inks and coatings to paper and packagings. The blades and method of the present invention achieve a friction resistant blade edge which allows coating or ink to be evenly applied to paper or board. The wear resistant blade has a longer life than conventional steel blades reducing the loss in production time due to frequent replacement of blades.

### BACKGROUND OF THE INVENTION

The paper or board manufactured for publication or packaging applications is frequently coated prior to printing. Properties such as opacity, gloss, smoothness and “printability” of a coated sheet are far improved over those of an uncoated sheet. Typically the coating is applied as a liquid mixture of clay, pigments, starch and/or other binders.

Coater blades are used for metering coatings and in particular waterborne calcium carbonate or clay based coatings on high grade paper used in the printing and packaging industry. Various types of coaters are used within the papermaking industry, but it is generally accepted that the highest quality coated paper surface is obtained using a blade coater. Printing doctor blades are used for metering ink in engraved cylinder used in printing. The coater blade scrapes or meters the amount of coat weight applied to the sheet, leaving a smooth, glossy surface. Any imperfection in the blade or its working edge will cause scratches or a non-uniform application of the coating. Also, because the coating itself contains abrasive particles the coater blade is subject to continuous and adverse wear. Therefore, in order to maintain sheet quality, the coater blades on a paper machine must be changed out at regular intervals. Paper machine doctor blades are also used in paper machines in many positions for maintenance and cleaning.

Change out intervals, typically are in the order of two to six times per day or more. Production losses are incurred due to the time needed to replace a blade and also because the operation of a new blade usually requires adjustment to ensure uniform coating and acquire distribution across the width of the machine. Some production losses due to coater blade changes are able to be reduced by scheduling the coater blade changes to coincide with other maintenance items that can be carried out while the machine runs. A wear resistant coater blade with a ceramic edge is available for use in coating. Ceramic edge blades can last several times longer than conventional steel blades, but regular replacement is still required. Therefore, lost production time is still substantial and the cost of ceramic blades is significantly more than that of the conventional steel blades.

A continuous crepe system is available for paper finishing. For example, U.S. Pat. No. 5,007,132 (Reid et al.) discloses use of a continuous blade which is tugged along the width by intermittently driven clamps in order to form the crepe in the paper. Such tugging, however adversely effects the smoothness and quality of coating on the coated paper or board resulting in streaks or scratches on the coating.

In the present invention, a friction resistant blade with a protective edge is provided which solves the problems of frequent change out, poor quality products, and uneven application of coatings.

### SUMMARY OF THE INVENTION

An object of the present invention is to provide a friction resistant blade with a protective layer. The protective layer is preferably chromium applied to at least the edge of the blade via electroplating.

Another object of the present invention is to provide a method of producing a friction resistant blade which comprises applying a protective layer, preferably a layer of chromium, to a blade-shaped substrate base.

### BRIEF DESCRIPTION OF DRAWINGS

FIG. 1 shows a friction resistant blade useful in the papermaking and printing industry and commonly referred to as a coater or doctor blade.

FIG. 2 shows a cross-sectional view of a friction resistant blade.

### DETAILED DESCRIPTION OF THE INVENTION

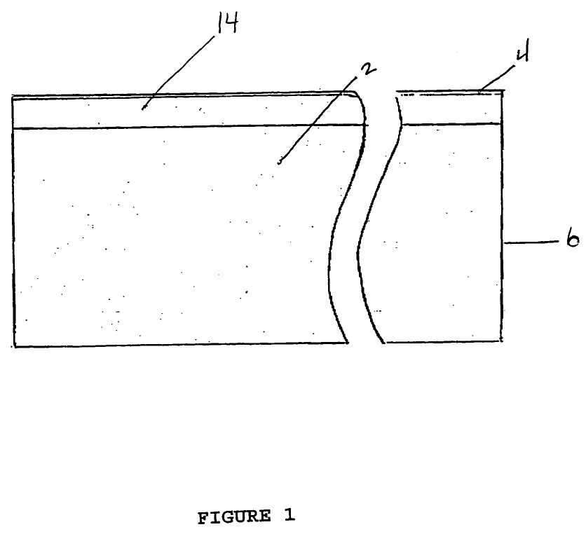

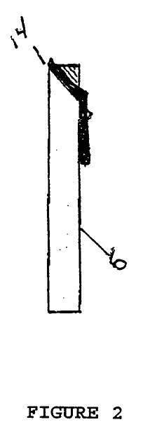

As shown in FIGS. 1 and 2, the present invention is a friction resistant coater or doctor blade. The blade 1 is comprised of a substrate base 2 formed in the shape of a blade with an edge 4. The edge 4 of the blade may be either beveled or square. The substrate base 2 is coated with a protective layer 14. The protective layer 14 is preferably chromium or low phosphorous electroless nickel. However, the protective layer 14 may comprise electroplated hard chrome. The protective layer 14 may be applied via a temperature controlled bath with a timed immersion to determine or and build the desired thickness. The protective layer 14 is heat treated to increase the hardness of the coating thereby increasing the useful life of the blade. The protective layer 14 comprises a Rockwell C hardness measurement of at least 70 after heat treatment.

Doctor blades of the present invention are useful in the printing industry. The blades can have a variation in thickness of between about 0.004 and 0.10 inches, with a honed edge on the reverse side of the blade. The blade substrate may be comprised of stainless steel, carbon strip steel or an electro-slag remelt, such as for example 1095 ESR. The blade substrate has a tensile strength of between 1800 and 1900 MPa, and preferably between 1840 and 1870 MPa. In embodiments where the blade substrate is carbon strip steel, the carbon content of the blade substrate will range between 0.0 and 1.1 percent carbon. In embodiments where the blade substrate is stainless steel, a 716/420 mod stainless steel is preferred. In one preferred embodiment the blade substrate does not contain chromium. The blades have angles on both the front and reverse sides. The blades may be diamond honed or ceramic superfinished. There may be an angle included on the back side of the blade ranging from about 4 to 13 degrees, and the front side may have an angled edge ranging from about 20 to 90 degrees. The blades further comprise a low phosphorous electroless nickel plating on the outside edge or alternatively on the entire blade. Low phosphorous electroless nickel has a phosphorous content of between two and five percent. In a preferred embodiment the phosphorous content is three percent. This blade substrate has a Rockwell hardness measurement of between 50 and 52 on a Rockwell C scale prior to coating. The coating provides the blade substrate with a Rockwell hardness measurement of between 60 and 65, or particularly about 63 (RC63) when plated. The coating is applied to the blade substrate at thickness between 0.0002 to 0.0004 per side, and then heat treated to about 750 degrees Fahrenheit for one hour. It is preferred that the heat treatment be completed in a convection oven. Heat treatment after plating increases hardness of the blades to greater than 70 on Rockwell C Scale. In a preferred embodiment, the Rockwell C hardness is about 71. When a lower temperature is used for heat treating, the resultant hardness of the blades is also lower. Additionally, the flexibility of the coating is increased as compared to other blade coatings due to periodic reverse cleaning and heat treating after coating application. For coater blades useful in the paper industry, which are manufactured in Germany and Sweden, all processing steps are performed on the raw blade substrate material which is initially in coil form. A honed included angle is applied to the edge from 1 to 90 degrees inclusive of the finish on the angle to be 0.000002 to 0.000003 inches. The blade may further comprise safety dimples, tabs, rivets, or pull holes if desired. Low phosphorous electroless nickel plating is applied to the blades at a thickness of 0.0003 to 0.0009 inches per side. Then the protectively coated blade substrate is heat treated in a convection oven at about 750 degrees Fahrenheit for one hour or until the hardness of the blade is at least Rockwell C 70 (RC 70). Furthermore, benefits provided to the blade in light of the increased hardness include longer life, more durability, less streaking, increased smoothness, increased gloss, lower coefficient of friction, erosion resistant heel of the blade, increased run time for the coater blade is three to four times greater than that of Blue Polished 1095 Steel.

The protective layer may cover all or any portion of the blade. However, in a preferred embodiment, the protective layer 14 is present on at least the blade edge 4 and may extend down the face 6 of the blade 1. The layer thickness may vary from 0.0001 inch to 0.015 inch and extend down the face 6 of the blade 1 from ⅜ inch to ¾ inch depending on the desired application. The length of the blade 1 may vary typically from 6 inches to 600 inches or more depending upon the application. The width of the blade 1 also varies typically from 0.5 inches to 6 inches depending on the desired application. The thickness of the blade may vary from about 0.002 to about 0.125 inches.

The blade 1 is formed of a substrate material, preferably carbon strip steel, stainless steel, stainless alloy, bronze or monel, depending upon desired hardness. The protective layer 14 on the blade 1 increases the wear of the blades and also enhances the performance of the blades and the products of papermaking or printing applications such as metering of coating or ink, maintenance or doctoring applications wherein these blades are used. The blade 1 can be coiled or fashioned in a roll-like manner. The protective layer 14 does not intermingle with the substrate material of the blade 1 upon heat treatment.

An embodiment wherein the edge 4 of blade 1 is beveled is depicted in FIG. 2. The angle of this bevel may vary from about 1° to about 90°.

Also provided is a method of making a friction resistant blade comprising applying to a blade-shaped substrate base a protective layer preferably to areas of the blade-shaped substrate base which contact various coatings used in paper making and printing applications. In a preferred embodiment, the protective layer is applied at least to the edge of the substrate base and can extend down the face of the substrate base. Preferably the protective layer is chromium and is applied via electroplating to the blade-shaped substrate base. However, other methods known in the art for application of a protective layer can also be used. The protective layer can vary according to application in thickness from 0.0001 inch to 0.015 inch and can extend down the face of the blade from ⅜ inch to ¾ inch depending on the desired application.

If an angled edge is desired, the blade angles are formed and then tested for conformity with an optical comparator. The blades are machine tested for hardness. Blades are examined for potential flatness or surface defects. A surface finish microscope is used to inspect the bevel finish. The blade may be further finished or polished. The blades may be punched to meet application specification. Blades may further be packaged in coiled rolls and with protective taped edges.

The methods and blades of the present invention are particularly useful for doctor blades and coater blades.

As would be understood by one of skill in the art upon reading this disclosure, the dimensions of the blade, protective layer thickness and the extent of blade coverage with the protective layer provided herein are merely exemplary and may be varied routinely by those of skill in the art depending upon the desired application.

What is claimed is:

1. A friction resistant blade comprising a blade-shaped substrate base with at least one edge and a protective layer applied to said blade-shaped substrate wherein said blade has at least one edge with a Rockwell C hardness of greater than 70.

2. The friction resistant blade of claim 1 wherein the protective layer is applied to the blade-shaped substrate and heat treated so that the blade exhibits increased Rockwell hardness measurements.

3. The friction resistant blade of claim 1 wherein the protective layer comprises low phosphorous electroless nickel.

4. The friction resistant blade of claim 1 wherein the protective layer is between 0.0002 to 0.0009 inches thick.

5. The friction resistant blade of claim 1 wherein the blade-shaped substrate base comprises carbon strip steel, stainless steel, stainless alloy, bronze or monel.

6. The friction resistant blade of claim 1 wherein the edge is beveled.

7. The friction resistant blade of claim 1 wherein the edge is square.

8. A method of producing a friction resistant blade comprising:
applying a protective layer to a blade-shaped substrate base;
heat treating said protective e layer on the blade-shaped substrate for an amount of time suitable to provide a Rockwell C hardness measurement of greater than 70 to said protective layer wherein said protective layer is applied to areas of the blade-shaped substrate which contact coatings.

9. The method of claim 8 wherein the protective layer comprises low phosphorous electroless nickel.
